(19) United States
(12) Patent Application Publication
(10) Pub. No.: US 2006/0169537 A1
(43) Pub. Date: Aug. 3, 2006

(54) TOOL BASKET FOR USE WITH SCAFFOLDING STRUCTURES

(76) Inventor: William R. Enochs, Harrisburg, MO (US)

Correspondence Address: BLACKWELL SANDERS PEPER MARTIN LLP, 720 OLIVE STREET, SUITE 2400, ST. LOUIS, MO, 63101, US

(21) Appl. No.: 10/905,988

(22) Filed: Jan. 28, 2005

(51) Int. Cl. E06C 5/32

(52) U.S. Cl. 182/129

(57) ABSTRACT

A tool basket adaptable for removably engaging a selected pair of upright scaffolding members associated with a typical scaffolding structure wherein the tool basket includes opposed side walls, opposed end walls, and a bottom wall extending therebetween forming an easily accessible storage compartment for holding and storing tools and other work related items. The bottom wall portion of the tool basket includes a pair of spaced apart socket members adapted for cooperatively receiving the upper end portion of the scaffolding support members, at least one of the socket members including an elongated receptacle for accommodating variations in the spacing between the pair of upright scaffolding support members, the length of the at least one elongated receptacle providing adjustability for engaging and capturing the pair of spaced apart scaffolding support members regardless of any variation in the distance therebetween.

### BACKGROUND OF INVENTION

The present invention relates generally to tool baskets and/or work baskets for holding tools and other objects and, more particularly, to various embodiments of a tool basket specifically configured for use with conventional scaffolding structures or other raised platforms typically used by workers while constructing, painting, and/or repairing a structure.

Scaffolding and other types of raised platforms are typically used by workers such as painters, drywall installers, brick and stone layers, and other construction workers while constructing, repairing and/or refurbishing homes, buildings and other structures. Depending upon the particular task at hand, a worker will utilize a wide variety of different types of tools and other work related items or accessories such as paint, paint brushes, paint rollers, drywall tape and cement, brick and/or stone cement, specialized tools and other work related items in order to accomplish the particular task at hand. Although tool belts adaptable for strapping around the waist of a worker are available for holding certain conventional tools, such belts are not adaptable for holding a wide variety of specialized tools used in many of the construction trades and the use of such tool belts can likewise be awkward and restrict movement of a worker particularly when used in the limited spaces provided for when working on scaffolding or other raised platforms. In addition, such belts are not adaptable for holding paint cans, buckets of cement or drywall compound, and other job specific tools, products, supplies and/or accessories which are necessary to complete the particular task or job application. As a result, there is a need for some type of device for use in association with scaffolding structures or other raised platforms where workers working on such scaffolding can conveniently place and store tools, paint, cement and other work related items and products at a convenient height on the scaffolding for use in completing the particular job related task at hand.

U.S. Pat. No. 6,098,749 discloses one type of work holder device invented by the present Applicant which is adapted to be removably mounted onto a scaffolding structure that includes vertically spaced, horizontally disposed cross members. This prior art device includes a work basket which is engageable with the upper end portion of an adjustable support frame which is attachable to the existing scaffolding structure. The base frame includes spaced, parallel, vertically elongated receiver members and mounting brackets carried by the base frame near the upper end portion thereof, the brackets being adaptable for engaging a horizontal cross member associated with the scaffolding so as to support the base frame against both downward and outward placement from the scaffolding. Vertically elongated extendable members are slidably mounted within the elongated receiver members associated with the base frame for vertical or lengthwise movement relative to the base frame. Clamping means are also provided for holding the extendable members in selected positions with respect to the base frame. The work basket includes integral sockets into which the upper ends of the extendable members are fitted. The elongated extendable members are adjustably slidable upwardly to any desired height and clamp means are used to hold the work basket in a particular desired position. This prior art work holder assembly includes many components including a supporting frame structure and is adjustable vertically to accommodate different workmen and different construction needs. Although this work holder assembly works well, it includes multiple components and takes additional time to install on the horizontal cross member of the scaffolding structure being used by a particular worker.

It is therefore desirable to provide a more simplified structure for providing a tool or work basket which is mountable or attachable to an existing scaffolding structure so as to provide a holding or storage container for placing tools and other work related items and products at a convenient height on the scaffolding structure for use by a worker so as to complete a particular work task.

Accordingly, the present invention is directed to a tool or work basket for use in conjunction with conventional scaffolding structures and other raised platforms which overcomes one or more of the problems set forth above and which is less complicated and includes fewer components than the work holder assembly disclosed in U.S. Pat. No. 6,098,749.

### SUMMARY OF INVENTION

Scaffolding structures typically come in standard sizes, although some variation in overall length and width may exist depending upon the particular manufacturer. This means that the distance or spacing between the upright elongated support members which form the scaffolding structure may likewise vary somewhat from one scaffolding structure to another. The present invention teaches the construction and use of a tool basket or work basket which includes adjustable means for engaging the upright support members associated with the top of the scaffolding structure adjacent the platform member upon which workers will stand to complete the job at hand. Typically, the scaffolding structure is erected to the desired height at which the worker must be elevated to accomplish a particular work application. The upper most vertical support members associated with the scaffolding structure will typically extend above the platform area upon which the workers will stand a standard or conventional distance so that side rails or other hand or guard rails may be attached thereto to somewhat enclose the worker within the platform area to provide some safety measure at the elevated height. The height of these upper most vertical support members can be selected at varying lengths so as to position the hand rails or guard rails at a convenient location relative to the worker standing on the platform area. The present tool baskets or work baskets are adaptable for engaging a selected pair of these upright scaffolding support members so that the present tool basket or work basket is conveniently positioned height wise relative to a worker standing on the work platform so that the worker can store and use tools and other work accessories and products from within the present work basket while working on the scaffolding structure. The present tool basket or work basket is quickly and easily engageable with a pair of the uppermost vertical scaffolding support members; it includes adjustment means for capturing and engaging a pair of uppermost scaffolding support members regardless of varying distances therebetween; and it provides a convenient holding container for work tools and the like at a convenient height relative to the worker.

More particularly, in one aspect of the present invention, the present tool basket or work basket is generally rectangular in shape and includes opposed side walls, opposed end walls, and a bottom wall extending therebetween forming an easily accessible storage compartment for holding and storing tools and other work related items. The bottom wall portion of the present tool basket includes a pair of spaced apart substantially aligned sockets which are shaped and dimensioned so as to cooperatively receive the upper end portion of any one of the uppermost vertically extending support members associated with a conventional scaffolding structure. One of the sockets is specifically configured so as to engage the upper end portion of one of the vertical scaffolding support members in a somewhat tight or snug fitting relationship whereas the other socket member is elongated so as to provide adjustability for engaging and capturing the upper end portion of a second vertically extending scaffolding support member regardless of any variation in the distance between the two spaced apart scaffolding support members. This second elongated socket member is shaped and configured widthwise so as to engage the upper end portion of a vertically extending scaffolding support member on at least opposed side portions of the support member whereas the elongated socket member also provides a channel along the length of the bottom wall member for providing adjustability and accommodating a pair of scaffolding support members which may be spaced at a distance which is different from or varies from standard industry practice. The present pair of sockets are provided at a depth sufficient to provide a stable platform for the present tool basket when the socket members are engaged with a pair of scaffolding support members.

The upper end portion of the side walls and/or end walls forming the present tool or work basket may likewise include a peripheral flange extending partially or completely around the perimeter of the present tool basket for easily grasping, holding and maneuvering the tool basket from one location to another. This peripheral flange member may include a specific handle mechanism and it may include a plurality of apertures associated therewith, the apertures being of varying shape and size so as to receive and hold a wide variety of different types of work tools such as screwdrivers, hammers, pliers, paint brushes, rollers, drywall tools, and the like. These tools would be held and stored around the periphery of the present tool basket thereby leaving the primary storage compartment open and accessible for use in holding other work tools and other work related products and accessories.

In use, the socket members associated with the bottom wall portion of the present tool basket are positioned and located over the upper end portions of the uppermost vertically extending scaffolding support members which extend above the worker platform area. When so positioned, the socket members are engaged with the scaffolding support members, this engagement holding the present tool basket in a stable, desired position above and adjacent to the scaffolding platform. Because one of the present socket members is elongated in shape, the length of the elongated socket member determines the degree of adjustability based upon the distance or spacing between the spaced pair of scaffolding support members to which the present tool basket is attached. Since this spacing between the scaffolding support members may vary between manufacturers and between different types of scaffolding structures, the elongated socket member will accommodate these spacing variations thereby enabling the present tool basket to be used in association with a wide variety of different scaffolding structures.

In another aspect of the present invention, the tool or work basket includes a pair of socket members wherein each socket member is elongated in shape so that each socket member can provide a degree of adjustability based upon the distance or spacing between the pair of scaffolding support members when the socket members are engaged therewith. In this particular embodiment, the pair of elongated socket members can be similarly constructed or the length of each elongated socket member can be different so as to provide a different degree of adjustability with each socket member. Even though each socket member will be elongated or oval in shape to provide adjustability, the width of each socket member will be sized and shaped to engage the scaffolding support members on at least the opposed side portions thereof so as to establish a tight, snug fit widthwise within each socket member. In addition, this embodiment can likewise include a peripheral flange extending partially or completely around the upper end portion of the side walls and/or end walls associated with the tool or work basket so as to provide a gripping surface. This peripheral flange can likewise include handle means or a wide variety of differently sized and shaped apertures for holding and receiving a wide variety of different tools adjacent the periphery of the present tool basket.

These and other aspects and advantage of the present invention will become apparent to those skilled in the art after considering the following detailed description in connection with the accompanying drawings.

### BRIEF DESCRIPTION OF DRAWINGS

For a better understanding of the present invention, reference may be made to the accompanying drawings.

FIG. 1 is a perspective view of one embodiment of the present tool basket constructed in accordance with the teachings of the present invention.

FIG. 2 is a top plan view of the tool basket of FIG. 1.

FIG. 3 is a bottom plan view of the tool basket of FIG. 1.

FIG. 4 is a side elevation view of the tool basket of FIG. 1.

FIG. 5 is an end elevational view of the tool basket of FIG. 1.

FIG. 6 is a top plan view of another embodiment of the present tool basket constructed in accordance with the teachings of the present invention.

FIG. 7 is a bottom plan view of the tool basket of FIG. 6.

FIG. 8 is a side elevational view of the tool basket of FIG. 6.

FIG. 9 is an end elevational view of the tool basket of FIG. 6.

FIG. 10 is a top plan view of still another embodiment of the present tool basket constructed in accordance with the teachings of the present invention.

FIG. 11 is a bottom plan view of the tool basket of FIG. 10.

### DETAILED DESCRIPTION

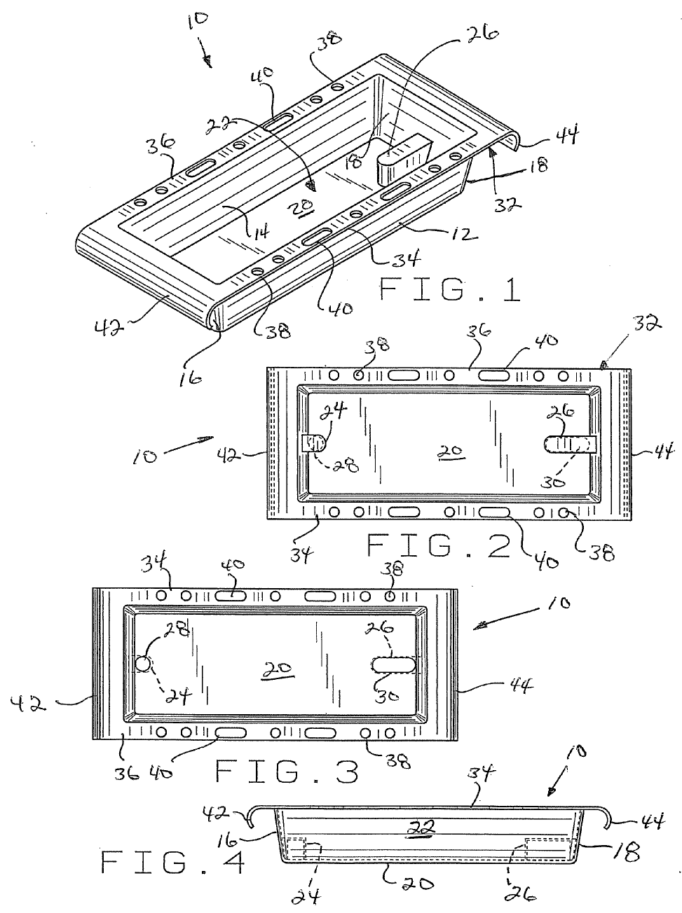

Referring to the drawings more particularly by reference number wherein like numerals refer to like parts, the numeral 10 in FIGS. 1-5 identifies one embodiment of a tool or work basket constructed according to the teachings of the present invention. The tool basket 10 can be of a one piece construction and includes opposed side walls 12 and 14, opposed end walls 16 and 18, and a bottom wall 20 extending therebetween. The wall members 12, 14, 16, 18 and 20 form an open box-type container defining an internal storage compartment or cavity 22 for receiving and holding a wide variety of different types of tools and other work related items and products. The bottom wall member 20 includes a pair of sockets 24 and 26, the socket members 24 and 26 being each respectively positioned adjacent corresponding end walls 16 and 18 as best illustrated in FIGS. 2-4.

Socket member 24 is centrally located along end wall 16 and extends inwardly towards the center of the storage compartment 22. Socket member 24 is specifically configured so as to cooperatively engage the upper end portion of any one of the upper most vertically extending scaffolding support members associated with a typical scaffolding structure. The socket receptacle 28 associated with the socket member 24 is illustrated in FIGS. 3 and 4 as being substantially circular in shape for cooperative engagement with circular type tubular support members typically associated with a wide variety of different scaffolding structures. Socket receptacle 28 is sized so as to frictionally engage the upper end portion of a particular scaffolding support member (not shown) in a somewhat snug fashion. Although the receptacle 28 is illustrated as being substantially circular in shape, it is recognized and anticipated that the receptacle 28 can be sized and shaped so as to be compatible with, and substantially conform to, the size and shape of any vertically extending scaffolding support members to which it will be attached. This would include a wide variety of other shapes and configurations including rectangular, square, oval, triangular, and other tubular and solid configurations.

In similar fashion, socket member 26 is likewise centrally located along the end wall 18 and likewise extends inwardly towards the center of storage compartment 22. Socket member 26 is also positioned in spaced apart substantial alignment with socket member 24 as best illustrated in FIGS. 2 and 3 and includes a socket receptacle 30 as best illustrated in FIG. 3. Socket receptacle 30 is elongated in configuration and extends substantially the full length of socket member 26. Socket receptacle 30 is likewise configured to cooperatively receive the upper end portion of any one of the upper most vertically extending scaffolding support members and since receptacle 30 is elongated in shape, it affords some adjustability in engaging a second scaffolding support member once socket member 24 is engaged with a first scaffolding support member. Because the vertically extending scaffolding support members are typically spaced at a substantially uniform distance from each other, regardless of the scaffolding structure, the elongated receptacle 30 associated with socket member 26 will normally accommodate any variation in spacing distance between a pair of scaffolding support members. The length of the socket member 26 as well as the length of the elongated receptacle 30 associated therewith will define the amount of adjustability associated with the tool basket 10 in capturing a selected pair of substantially aligned spaced apart scaffolding support members. Since manufacturing tolerances and other factors, including different spacing criteria established by different scaffolding manufacturers, contribute to variations in the distance or spacing between two substantially aligned scaffolding support members, the elongated socket member 26 compensates for such variations and allows the present tool basket 10 to be cooperatively engaged with a pair of upper most scaffolding support members associated with a wide variety of scaffolding structures, regardless of differences in the spacing or distance existing between the opposed support members. The amount of adjustability is determined by the overall length of the socket member 26, which socket can be further extended inwardly towards the center of the storage compartment 22 as required to increase its overall length. The length of socket member 26 including the length of the elongated receptacle 30 associated therewith will determine the amount adjustability afforded by the present tool basket 10.

As best illustrated in FIGS. 1, 4 and 5, the height or depth of the socket members 24 and 26 should be such that when the upper end portions of a pair of scaffolding support members are respectively engaged with the socket receptacles 28 and 30, a stable platform is provided and the present tool basket 10 will remain in a stable and supportive position on top of the scaffolding support members. To achieve this end, the depth of the receptacles 28 and 30 can be varied depending upon the overall size of the tool basket 10 as well as the anticipated load of tools and other work items and products which will be stored within the storage compartment 22. Although the socket members 24 and 26 are illustrated as extending upwardly from the bottom wall 20 into the interior portion of the storage compartment 22, it is recognized and anticipated that the socket members 24 and 26 can likewise be configured so as to extend or project downwardly from the bottom wall 20 so as not to intrude into or otherwise restrict the usable space within the storage compartment 22.

The tool basket or work basket 10 may also include a peripheral flange 32 which may extend either partially or completely around the upper periphery of the tool basket 10 as best shown in FIGS. 1-3. In the embodiment illustrated in FIGS. 1-3, the peripheral flange 32 extends outwardly away from the storage compartment 22 adjacent the upper edge portion of each of the respective side walls and end walls 12, 14, 16 and 18. More particularly, flange portions 34 and 36 associated respectively with side walls 12 and 14 include a plurality of apertures or openings such as the apertures 38 and 40 illustrated in FIGS. 1-3 which are specifically sized and shaped so as to receive and hold various tools utilized by a worker in accomplishing a specific work task such as screwdrivers, hammers, pliers, paint brushes, paint rollers and the like. In the specific embodiment illustrated in FIGS. 1-3, the aperture 38 is substantially circular in shape and is adapted to receive a wide variety of different types of screwdrivers and other elongated/slender type tools. On the other hand, aperture 40 is elongated and specifically configured to receive the claw portion (nail removing portion) of a hammer or other similar device. It is recognized and anticipated that the number of apertures and the specific size and shape of such apertures can vary widely depending upon the size and shape of the particular work tools to be received therewithin. It is also recognized that the width of the flange portions 34 and 36 can likewise vary depending upon the size of the apertures associated therewith. Once tools are inserted within the respective apertures associated with flange portions 34 and 36, such as the apertures 38 and 40, such tools will be held and retained adjacent the side walls 12 and/or 14 thereby freeing up the storage compartment 22 for holding other work related items, products and accessories.

Peripheral flange 32 also includes flange portions 42 and 44 positioned adjacent the upper edge portion of end walls 16 and 18 respectively, flange portions 42 and 44 being curved downwardly as best illustrated in FIG. 4 so as to function as handle means for easily grasping and carrying the tool basket 10 from one location to another including installing the tool basket 10 on a pair of vertically extending scaffolding support members. It is recognized and anticipated that other shapes and configurations associated with flange portions 42 and 44 can likewise be utilized to form gripping or handle means for easily grasping, carrying and/or otherwise transporting the tool basket 10 from one location to another.

In use, the present tool basket 10 is engaged with the upper most vertically extending scaffolding support members positioned adjacent the platform area upon which workers will stand in order to complete a particular work related task. Once the scaffolding structure has been assembled to the desired height at which a worker must be elevated to accomplish a particular work application, a platform area is established and additional vertically extending support members are typically engaged with the scaffolding structure so as to extend above the platform area to form side rails around the work platform to somewhat enclose the worker therewithin at the elevated height. The height of these upper most vertically extending scaffolding support members can be selected at varying lengths so as to position the side rails or guard rails at a convenient location relative to a worker standing on the platform area. The present tool basket 10 is then carried to the top of the scaffolding structure and is positioned for engagement with a selected pair of these upright vertically extending support members such that the socket members 24 and 26 can be engaged respectively therewith. To accomplish this task, socket receptacle 28 is first engaged with one of the selected pair of upright scaffolding support members and, thereafter, socket receptacle 30 is then maneuvered and positioned into engagement with the other of the selected pair of scaffolding support members. Due to variations between the distance or spacing of the selected pair of scaffolding support members, the overall length of the socket receptacle 30 defines the range of adjustment afforded by the tool basket 10 so as to capture the second upright scaffolding support member regardless of any variation in the distance between the selected pair of support members. Since socket receptacle 28 is specifically shaped and dimensioned so as to cooperatively engage the upper end portion of one of the selected pair of scaffolding support members, a tight or somewhat snug fit between the receptacle 28 and the scaffolding support member is achieved.

On the other hand, since socket receptacle 30 is elongated as best illustrated in FIGS. 1-3 to provide adjustment means as described above, the width of receptacle 30 is specifically sized and shaped so as to engage the upper end portion of one of the vertically extending scaffolding support members on at least the opposed side portions thereof so as to likewise establish a somewhat tight or snug fit widthwise within the receptacle 30. In other words, the width of socket receptacle 30 is selected so as to frictionally engage opposed sides of the scaffolding support member positioned therewithin even though such support member may be moved lengthwise along the elongated channel formed by the receptacle 30 to capture the engaged support member. The elongated channel associated with the receptacle 30 provides adjustability and accommodates a pair of scaffolding support members which may be spaced at a distance which is different from or varies from standard industry practice. Once the socket members 24 and 26 are positioned over a selected pair of scaffolding support members, socket receptacles 28 and 30 are respectively engaged therewith thereby holding the tool basket 10 in a stable, usable position relative to the scaffolding platform. Because of the frictional engagement between the socket members 24 and 26 and the upper end portions of the selected pair of scaffolding support members, the tool basket 10 can be easily and selectively attached and removed to the scaffolding structure at will. No other brackets, J-bolts, hooks, or other fastening members are necessary in order to removably mount the present tool basket 10 to a scaffolding structure.

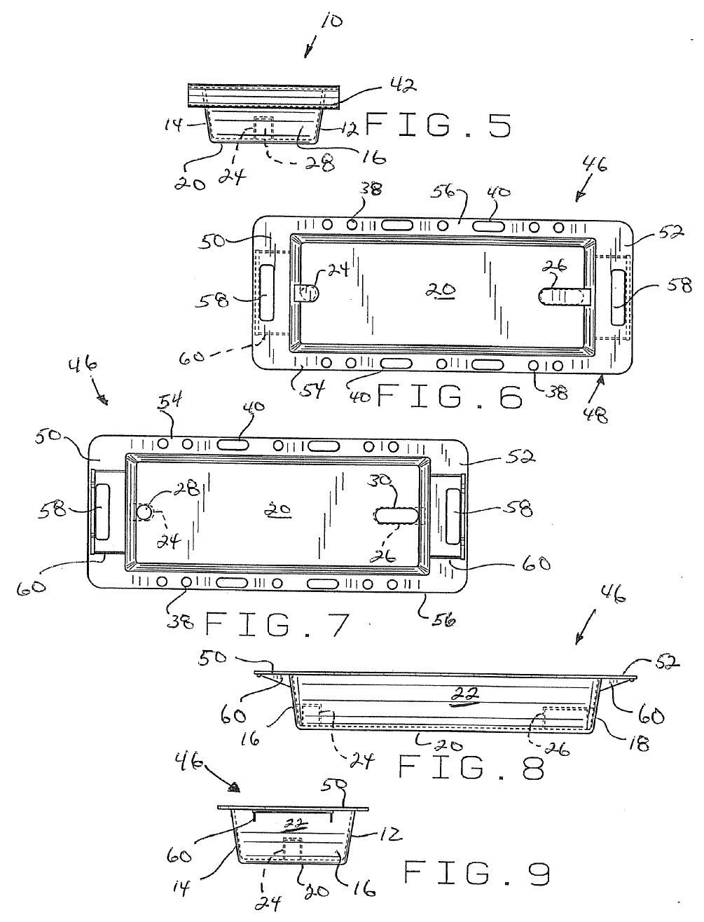

FIGS. 6-9 disclose another embodiment 46 of the present tool basket, the tool basket 46 being substantially similar in construction and operation to the tool basket 10 but differs therefrom only in that the peripheral flange 48 includes flange portions 50 and 52 which are configured differently as compared to flange portions 42 and 44. Since the structure and operation of most of the tool basket 46 is substantially identical to the construction and operation of tool basket 10, like numbers associated with tool basket 46 represent structure previously discussed and disclosed with respect to tool basket 10. On the other hand, peripheral flange 48 associated with tool basket 46 includes flange portions 50 and 52 associated with the upper edge portion of end walls 16 and 18 respectively whereas flange portions 54 and 56 are associated with the upper edge portion of side walls 12 and 14 respectively. Flange portions 54 and 56 are substantially identical to flange portions 34 and 36 previously described with respect to tool basket 10 and likewise include a plurality of differently configured apertures such as the apertures 38 and 40 previously discussed. Unlike flange portions 42 and 44, peripheral flange portions 50 and 52 are substantially planar and do not include any curvature for facilitating the grasping and carrying of tool basket 46. Instead, flange portions 50 and 52 each include an elongated opening 58 through which a worker's hand is easily received for grasping, carrying and transporting the tool basket 46 from one location to another. Since flange portions 50 and 52 are wider than flange portions 54 and 56 and extend outwardly a greater distance away from end walls 16 and 18 respectively as compared to flange portions 42 and 44, a reinforcing structure 60 is provided on the underside portion of each flange portion 50 and 52 respectively adjacent the openings 58 as best illustrated in FIG. 7 to provide additional support and strength to the flange portions 50 and 52, particularly, when the handle openings 58 are utilized to transport a load housed within the storage compartment 22. The reinforcing structure 60 provides additional strength and stability to the flange portions 50 and 52 and prevents these flange portions from buckling or otherwise breaking when a heavy load of tools and/or other work related items are housed within the storage compartment 22 and the tool basket 46 is carried by flange portions 50 and 52 from one location to another.

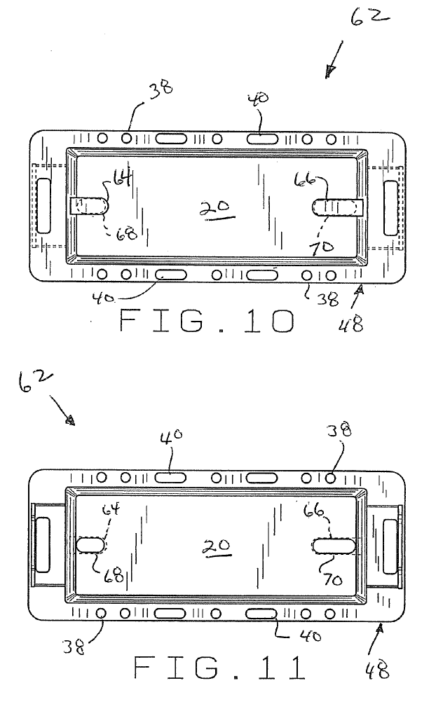

FIGS. 10 and 11 disclose still another embodiment 62 to the present tool basket, the tool basket 62 being substantially similar in construction and operation to the tool basket 46 but differs therefrom only in that both socket members 64 and 66 include respective elongated receptacles 68 and 70. Since the structure and operation of most of the tool basket 62 is substantially identical to the construction and operation of the tool basket 46, like members associated with tool basket 62 again represent structure previously discussed and disclosed with respect to tool basket 46. In similar fashion, socket member 66 and its corresponding elongated receptacle 70 are substantially similar to socket member 26 and its corresponding elongated receptacle 30 previously discussed with respect to tool baskets 10 and 46. The main different with respect to tool basket 62 lies in the size and shape of socket member 64 and its corresponding receptacle 68. Unlike socket member 24 and its corresponding receptacle 28 which are shaped and dimensioned so as to substantially conform to the shape and dimension of the pair of upright scaffolding support members to which it is attached, the socket member 64 and its corresponding receptacle 68 are also elongated similar to socket members 26 and 66 so as to likewise provide some degree of adjustability when the pair of socket members are maneuvered and positioned into engagement with the pair of scaffolding support members. In this regard, socket member 64 and its corresponding receptacle 68 can be sized and shaped so as to be substantially similar to elongated socket member 66 and its corresponding elongated receptacle 70, or socket member 64 and its corresponding receptacle 68 can be sized and shaped so as to be longer or shorter than socket member 66 and receptacle 70. In other words, the length of socket member 64 and the corresponding length of elongated receptacle 68 can be greater than, equal to, or less than the length of socket member 66 and its corresponding elongated receptacle 70. In embodiment 62 illustrated in FIGS. 10 and 11, socket member 64 and its corresponding receptacle 68 are illustrated as being shorter in overall length as compared to socket member 66 and receptacle 70. This is for illustrative purposes only. This feature of the present invention increases the amount of adjustability associated with tool basket 62 since both socket members afford a degree of adjustability without increasing the overall size and shape of the tool basket. In this particular embodiment, the amount of adjustability is determined by the overall length of both of the elongated socket receptacles 68 and 70.

Since both socket receptacles 68 and 70 form elongated channels for receiving a selected pair of upright scaffolding support members, as discussed above with respect to elongated socket receptacle 30, even though the upper end portions of the selected pair of scaffolding support members may be moved lengthwise within the elongated socket receptacles 68 and 70 so as to capture the selected pair of scaffolding support members, the width of each socket receptacle 68 and 70 is selected so as to frictionally engage the opposed sides of the scaffolding support members positioned therewithin depending upon the particular size and shape of the scaffolding support members. It is this frictional engagement with at least the opposed sides of the scaffolding support members positioned therewithin which establishes a somewhat tight or snug fit widthwise within the respective receptacles 68 and 70. It is this frictional engagement which will hold the tool basket 62 in a stable and supportive position on top of the scaffolding support members when engaged therewith. It is also recognized and anticipated that the socket 64 and its corresponding elongated receptacle 68 may be oval in shape, rectangular in shape, or some other shape so long as it provides an additional degree of adjustability with respect to socket member 64.

Although tool basket 62 is illustrated as being substantially identical to tool basket 46 including having a substantially similar peripheral flange 48 associated therewith, it is also recognized and anticipated that peripheral flange 48 could be replaced with peripheral flange 32 illustrated with respect to tool basket 10 including flange portions 42 and 44 without departing from the spirit and scope of the present invention. It is also recognized and anticipated that any other peripheral flange construction and/or arrangement can be associated with any of the various embodiments of the present tool basket illustrated in FIGS. 1-11.

It is also anticipated that all embodiments of the present tool or work basket can be made using an injected molded plastic resin, although other materials may likewise be utilized. Still further, although the tool baskets 10, 46 and 62 are illustrated as being substantially rectangular in overall shape, it is recognized that the overall dimensions of the present tool basket as well as the specific shape and configuration of the various members associated therewith are also subject to wide variations and may be sized and shaped into a wide variety of different sizes and configurations such as square, elliptical, oval and so forth, so long as the sockets 24, 26, 64 and 66 are compatible for cooperatively engaging the upper end portions of a selected pair of spaced apart scaffolding support members. It is also recognized and anticipated that the size and shape of the socket receptacles 28, 30, 68 and 70 may likewise be sized and shaped into a wide variety of different sizes and configurations so as to be compatible with the size and shape of the upper end portions of the vertically extending scaffolding support members. All of these changes and/or modifications can be accomplished without impairing the teachings and practices of the present invention. Other variations and modifications to the various elements comprising the present structures are also contemplated.

As is evident from the foregoing description certain aspects of the present invention are not limited by the particular details of the examples illustrated herein, and it is therefore contemplated that other changes, modifications, variations and other uses and applications, or equivalents thereof, of the present invention will become apparent to those skilled in the art after considering this specification and the accompanying drawings. It is accordingly intended that the claims set forth below shall cover all such changes, modifications, variations and other uses and applications that do not depart from the spirit and scope of the present invention as described herein.

Other aspects, objects and advantages of the present invention can be obtained from a study of the drawings, the disclosure and the appended claims.

What is claimed is:

1. A tool basket for removable attachment to a scaffolding structure wherein the scaffolding structure includes at least one pair of spaced apart upright scaffolding support members, said tool basket comprising:
a member having side walls and a bottom wall extending therebetween defining a storage compartment;
said bottom wall including a pair of spaced apart socket members adaptable for cooperatively engaging the at least one pair of spaced apart upright scaffolding support members, at least one of said socket members including an elongated receptacle which is sized and shaped for cooperatively engaging at least one of the pair of upright scaffolding support members, said elongated receptacle being positioned and located so as to accommodate variations in the spacing between the at least one pair of spaced apart upright scaffolding support members when said socket members are cooperatively engaged therewith.

2. The tool basket defined in claim 1 including a peripheral flange extending at least partially around the periphery of said side walls, at least a portion of said peripheral flange including a plurality of apertures.

3. The tool basket defined in claim 2 wherein at least a portion of said peripheral flange includes handle means.

4. The tool basket defined in claim 2 wherein at least some of said apertures are sized and shaped differently so as to receive and hold various tools or other objects.

5. The tool basket defined in claim 1 wherein said member having side walls and a bottom wall extending therebetween is substantially rectangular in shape.

6. The tool basket defined in claim 1 wherein said member having side walls and a bottom wall extending therebetween is substantially square in shape.

7. The tool basket defined in claim 1 wherein the other of said socket members includes a receptacle which is sized and shaped so as to substantially conform to the size and shape of the upper end portion of at least one of the pair of upright scaffolding support members.

8. The tool basket defined in claim 1 wherein the other of said socket members includes an elongated receptacle which is sized and shaped for cooperatively engaging at least one of the pair of upright scaffolding support members, said elongated receptacle being positioned and located so as to accommodate variations in the spacing between the at least one pair of spaced apart upright scaffolding support members when said socket members are cooperatively engaged therewith.

9. A tool basket for removable attachment to a scaffolding structure wherein the scaffolding structure includes at least one pair of spaced apart upright scaffolding support members, said tool basket comprising:
opposed side walls, opposed end walls and a bottom wall extending therebetween defining a storage compartment for holding tools and the like;
said bottom wall including a pair of spaced apart socket members adapted for cooperatively engaging the at least one pair of upright scaffolding support members, at least one of said socket members including an elongated receptacle for accommodating variations in the spacing between the at least one pair of spaced apart upright scaffolding support members when said socket members are cooperatively engaged therewith.

10. The tool basket defined in claim 9 including a peripheral flange extending at least partially around the periphery of the opposed side walls and opposed end walls, at least a portion of said peripheral flange including a plurality of apertures.

11. The tool basket defined in claim 10 wherein at least a portion of said peripheral flange includes handle means.

12. The tool basket defined in claim 11 wherein said handle means includes a portion of said peripheral flange adjacent said respective opposed end walls, said peripheral flange portions adjacent said opposed end walls being curved downwardly.

13. The tool basket defined in claim 11 wherein said handle means includes a portion of said peripheral flange adjacent said respective opposed end walls, said peripheral flange portions adjacent said opposed end walls each including an elongated opening adaptable for receiving a worker's hand for carrying said tool basket from one location to another.

14. The tool basket defined in claim 9 including a peripheral flange extending around the upper periphery of said opposed side walls and opposed end walls, said peripheral flange adjacent said opposed side walls including a plurality of openings, at least some of said openings being differently sized and shaped to receive and hold various tools or other objects.

15. The tool basket defined in claim 14 wherein the peripheral flange adjacent said opposed end walls are curved downwardly.

16. The tool basket defined in claim 14 wherein said peripheral flange adjacent said opposed end walls each include an elongated opening sized and shaped to be grasped by a worker's hand.

17. The tool basket defined in claim 9 wherein said pair of spaced apart socket members project upwardly from said bottom wall into the storage compartment.

18. The tool basket defined in claim 9 wherein said pair of spaced socket members project downwardly from said bottom wall away from said storage compartment.

19. The tool basket defined in claim 9 wherein the other of said pair of spaced apart socket members includes a receptacle which is sized and shaped so as to substantially conform to the size and shape of the upper end portion of at least one of the pair of upright scaffolding support members.

20. The tool basket defined in claim 9 wherein the other of said pair of upright scaffolding support members includes an elongated receptacle which is sized and shaped for cooperatively engaging at least one of the pair of upright scaffolding support members for accommodating variations in the spacing between the at least one pair of spaced apart upright scaffolding support members when said socket members are cooperatively engaged therewith.

21. A work basket adapted to be removably mounted to a scaffolding structure wherein the scaffolding structures includes a pair of spaced apart upright scaffolding support members, said work basket comprising:
spaced side walls, spaced end walls, and a bottom wall extending therebetween defining a storage compartment;
a peripheral flange extending at least partially around the periphery of said spaced side walls and/or spaced end walls;
said bottom wall including a pair of spaced apart socket members, one of said socket members including a receptacle which is sized and shaped so as to substantially conform to the size and shape of the upper end portion of at least one of the pair of upright scaffolding support members, the other of said socket members including an elongated receptacle which is sized and shaped for cooperatively engaging at least the other of the pair of upright scaffolding support members, said elongated receptacle accommodating variations in the spacing between the pair of spaced apart upright scaffolding support members such that when said pair of socket members are engaged with the pair of upright scaffolding support members, said tool basket is removably attached to the scaffolding structure.

22. The work basket defined in claim 21 wherein at least a portion of said peripheral flange includes a plurality of openings adaptable for receiving and holding various tools or other objects.

23. The work basket defined in claim 21 wherein at least a portion of said peripheral flange includes handle means.

24. The work basket defined in claim 21 wherein said work basket is substantially rectangular in shape.

25. A tool basket for removable attachment to a scaffolding structure wherein the scaffolding structure includes a pair of spaced apart upright scaffolding support members, said tool basket comprising:
opposed side walls, opposed end walls, and a bottom wall extending therebetween defining a storage compartment;
a peripheral flange extending around the upper periphery of said side walls and end walls, the peripheral flange positioned and located adjacent said side walls including a plurality of openings adaptable for receiving and holding various tools or other objects, the peripheral flange positioned and located adjacent said opposed end walls including handle means;
said bottom wall including a pair of spaced apart socket members adapted for cooperatively engaging the pair of upright scaffolding support members, one of said socket members including a receptacle which is shaped and dimensioned so as to substantially conform to the shape and dimension of the upper end portion of each of the pair of upright scaffolding support members, the other of said socket members including an elongated receptacle which is shaped and dimensioned for accommodating variations in the spacing between the pair of upright scaffolding support members when said pair of socket members are cooperatively engaged therewith.

26. The tool basket defined in claim 25 wherein said socket members are centrally located along the length of the opposed end walls.

27. A work basket for removable attachment to a scaffolding structure wherein the scaffolding structure includes a pair of spaced apart upright scaffolding support members, said work basket comprising:
spaced side walls, spaced end walls, and a bottom wall extending therebetween defining a storage compartment;
said bottom wall including a pair of spaced apart socket members adapted for cooperatively engaging the pair of upright scaffolding support members, each of said socket members including an elongated receptacle which is shaped and dimensioned for accommodating variations in the spacing between the pair of upright scaffolding support members when said pair of socket members are cooperatively engaged therewith.

28. The work basket defined in claim 27 including a peripheral flange extending at least partially around the periphery of the spaced side walls and/or spaced end walls.

29. The work basket defined in claim 28 wherein at least a portion of said peripheral flange includes a plurality of openings adaptable for receiving and holding various tools or other objects.

30. The work basket defined in claim 28 wherein at least a portion of said peripheral flange includes handle means.
